(19) United States
(12) Patent Application Publication
(10) Pub. No.: US 2008/0129857 A1
(43) Pub. Date: Jun. 5, 2008

(54) Method And Camera With Multiple Resolution

(76) Inventors: Jean-Marie Vau, Paris (FR); Nicolas Touchard, Suresnes (FR); Christophe E. Papin, Bois Colombes (FR)

Correspondence Address: EASTMAN KODAK COMPANY;PATENT LEGAL STAFF, 343 STATE STREET, ROCHESTER, NY, 14650-2201, US

(21) Appl. No.: 11/571,573

(22) PCT Filed: Jun. 13, 2005
(86) PCT No.: PCT/EP05/06309

§ 371 Date: Jan. 3, 2007

(30) Foreign Application Priority Data
Jul. 5, 2004 (FR) 0407411

(51) Int. Cl. H04N 5/232

(52) U.S. Cl. 348/345; 348/E05.042

(57) ABSTRACT

A shooting method in response to a shot release includes
the capture (10) of a first image (12), according to a first shooting field, using a camera (13) equipped with a variable focus lens set to a first focal length; the automatic search (20) in the first image of interest zones (16a, 16b), and when at least one interest zone is found; the automatic modification of the focal length to tighten the shooting field around the interest zone; the automatic capture of at least one second image (24a, 24b) according to the tightened shooting field; and the automatic creation of a composite image (32) by combining the first image and the second image.

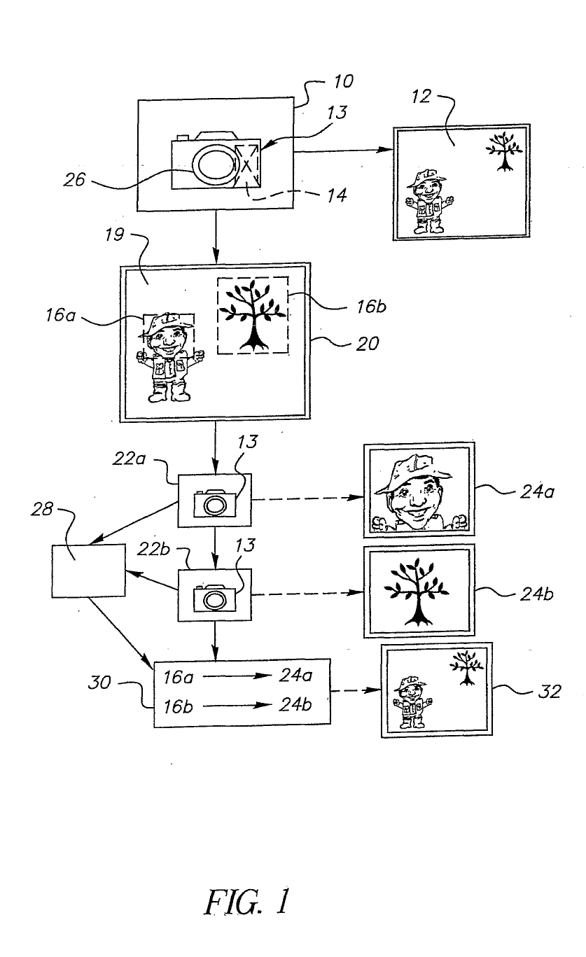

### FIELD OF THE INVENTION

The present invention relates to a method and camera enabling the capture of images with locally improved resolution. The invention has applications especially for digital cameras such as photographic cameras, phonecams, or generally any equipment provided with an image sensor.

### BACKGROUND OF THE INVENTION

Digital camera means built in to telecommunication equipment, such as mobile phones or phonecams, generally do not enable very high quality image capture. The quality failing stems from several factors. Because of its necessarily reduced weight and dimensions, mobile equipment does not have sophisticated lenses. Similarly, the digital image sensor combined with it generally has a resolution inferior to that of photographic cameras.

The modest potential of the shooting means, and especially that of phonecams, is justified, at least in part, by the remote transmission constraints of image files. Indeed, the files must have a digital weight that is compatible with the communication bandwidth. Another justification can be found in the reduced dimensions of the control screen used to display the images, and which generally gives an impression of satisfactory quality.

To improve image quality, variable focus lenses have been proposed. These are lens systems with liquid lenses in which the curve of a contact meniscus between two non-miscible liquids can be modified by the action of an electric field. For information, one can refer to documents (1) and (2) whose references are given at the end of the description. Variable focus lens systems enable cameras to be equipped with focusing and/or zoom functions.

In spite of the improvements mentioned above, digital images captured using phonecams generally have insufficient quality to be used for an enlargement or photographic hardcopy. Thus, when displaying the image on a large screen or when printing the image, the resolution limits appear in a more significant, sometimes disruptive way.

The possibilities for transmitting images remotely, the moderate cost of cameras targeted at the general public, the energy and memory resources of mobile equipment, and, in addition, the quality and resolution of the images obtained, thus seem to have conflicting objectives.

### SUMMARY OF THE INVENTION

It is the purpose of the invention to propose a method and camera enabling images to be captured that are capable of being enlarged while keeping a high quality of clarity.

It is also an object of the invention to enable the capture of such images using equipment that may have, if necessary, modest shooting means.

Yet another object is to propose a method and camera whose cost is particularly low in relation to the potential gain in image quality.

To achieve these goals, the object of the invention is more precisely a shooting method comprising, in response to releasing a shot:

the capture of a first image, according to a first shooting field, using a camera having a variable focus lens set to a first focal length, preferably less than the maximum focal length of the lens,

the automatic search in the first image of interest zones, and when at least one interest zone is found,

the automatic modification of the focal length to tighten the shooting field around the interest zone,

the automatic capture of a second image following the tightened shooting field, and

the automatic creation of a composite image by combining the first image and the second image.

The composite image finally obtained thus has zones in which the image resolution is higher: these are interest zones. Indeed each interest zone is captured with the full resolution of the camera's image sensor, or at least using a large area of the sensor, while it occupies only a part of the area of the final image. The interest zones correspond, for example, to faces or textured parts of the image, whose detail generally attracts the viewer's attention. However, the other zones retain a more restricted resolution. These are, for example, zones of sky, or background zones. The data of these zones effectively comes from the first captured image, i.e. the image for which a wider field is covered by the sensor.

The capture of the second images, corresponding to the interest zones, preferably occurs very quickly after the capture of the first image, and this automatically, without it being necessary for the user to press the release again. The shooting field is tightened by increasing the focal length of the lens. In particular it can be tightened to reach an edge of the selected interest zone.

According to an improvement, it is also possible to automatically modify the tilt of the lens's optical axis to automatically direct the optical axis towards each area of interest at the time of capturing the second corresponding images.

By directing the optical axis towards the interest zones, it is possible to further tighten the shooting field, in particular for interest zones located at an edge of the initial shooting field.

Indeed, second images are captured automatically, i.e. without the user having to change the framing deliberately. Thus, a strong reduction of the shooting field, performed without modifying the optical axis would exclude from the field certain peripheral zones and would only enable efficient implementation of the method for the central zones; However, the tilt of the optical axis from the center of the first image towards the center of an interest zone enables the shooting field to be centered on this interest zone for the capture of a second image. Modification of the lens's optical axis can occur, for example, by making a lens or an optical system pivot slightly, using an actuator such as a piezoelectric actuator. Another solution consists in using an optical wedge that can be directed by rotation, as described in the document (3) whose references are given at the end of the description.

Modification of the shooting field can advantageously be accompanied by an automatic focusing on the interest zone at the time of each capture of a second image. This enables the sharpness of the second image(s) captured to be improved.

Searching for interest zones within an image can satisfy various criteria. Most simply, image zones having the highest spatial gradients of light intensity can be selected as interest zones. This means that uniform expanses of sky, water, greenery, ground etc. can be excluded. In a more sophisticated way, image zones having dominating colors identified as skin colors can be selected as interest zones. This means that human faces can be selected as interest zones. Other techniques amount to identifying preset geometrical patterns in the image, corresponding, for example, to the mouth and eyes. Zones surrounding these patterns are considered as corresponding to a human face and are selected as interest zones.

As an illustration of interest zone search techniques, one can refer to documents (6) and (7) whose references are given at the end of the description.

As shown above, the images centered on interest zones, i.e. the second images, are preferably captured very quickly following the first image. If this is the case, it may be assumed that the overall scene and the interest zones it contains are more or less fixed, at least as a first approximation.

It is nevertheless possible to implement the method for capturing images of scenes in which the subjects are moving fast. This is the case for photographing sports subjects, for example.

In this case, the method may be supplemented by an estimate of the movement of the iconic content of each interest zone. This estimate can be used when creating the composite image to correct any displacement or distortion of the iconic content of each interest zone between the capture of the first image and the capture of each second image, respectively. The movement can be estimated from parameters that correspond to the focusing on the interest zones. These are, for example, a focusing difference, or an optical axis difference between the first and second images, a zoom factor and/or a latency time between the capture of the first and second images. Thus, any movements in the scene or of the user holding the camera do not prevent the correct construction of the final composite image.

The final image is constructed by combining the first and second images. This is preferably done using a JPEG 2000 type format which enables the combination of various images parts with different resolutions. Construction of the final image essentially consists in replacing the interest zones of the first image with the corresponding second images. The image parts are replaced by assigning to the second images an enlargement ratio enabling their insertion at the scale of the first image. This ratio depends on the modification of the focal length made for capturing each of the second images. The construction of a composite image, also called variable resolution image, employs known substitution and reconstruction techniques. For information, one can refer to document (4) whose references are given at the end of the description.

The invention also relates to a camera for implementing the method as described above. While the camera can also be used to capture image sequences, like a motion picture camera, it is mainly the function of capturing still images that is dealt with here.

The device can be a digital camera properly speaking or, as mentioned in the introduction, a device combining the functions of camera and telecommunication, such as a phonecam.

The camera comprises a variable focus lens, and image analysis means for detecting interest zones within the image. The lens is controlled by the analysis means to perform a framing tightened around at least one interest zone of a captured image, for the capture of at least one additional image corresponding to the interest zone.

The presence of a camera lens with variable focal length, in addition to adjustment of the focal length according to the invention, enables users to be offered a conventional zoom function. A mechanism can then be provided to prevent the user from adjusting the zoom to the maximum focal length when capturing the first image, so as to leave a margin for tightening the shooting field for the automatic capture, if necessary, of second images.

While the lens with variable focal length can be a lens equipped with a motor for moving a solid lens system, it is preferably an electrostatically-controlled lens system with liquid lenses. In particular these are lenses of the type described by documents (1) and (2) mentioned above. Liquid lenses have the advantage of low mechanical inertia. Thus they adapt easily to fast modification of the focal length. This property enables the first and second shots to be captured in quick succession, so that the user does not have to make a special effort to maintain the framing during the successive shots. If the linking of the shots is sufficiently fast, the user may not perceive the implementation of the method.

Creation of the composite image can take place or not in the camera. The camera can simply provide the digital data of the first and second images. It can also be equipped with composite image creation means using the digital data of all the images captured in response to a release by the user, and thus provide the data for the composite image directly.

The composite image creation means and the previously mentioned image analysis means can comprise a dedicated central processing unit or microprocessor programmed for appropriate digital data processing.

### DETAILED DESCRIPTION OF THE INVENTION

Other characteristics and advantages of the invention will appear in the following description, with reference to the FIGURE of the appended drawing. This description is given purely as an illustration and is not limiting. The sole FIGURE is a flowchart summarizing the steps of a particular implementation of a method according to the invention.

For simplification, the term “image” is used to denote the photographic images captured by the camera and also to denote the digital data or digital file corresponding to the image.

A first step 10 of the method comprises the capture of a first image 12. The image is captured in response to a shot release and corresponds to a framing and shooting field defined by the user. The framing, more or less fortuitous, can be controlled using the camera's viewer or a small control screen. The shooting field is also determined by the user who can move closer or further from the scene to be photographed or can use the adjustment of the camera's zoom. The zoom acts on the focal length, based on the lens's field of view.

The image supplied by the camera's image sensor 13 is sent to a central processing unit 14 where it is analyzed to extract the interest zones 16a, 16b. As previously mentioned this means determining zones having strong spatial gradients of light intensity in the image, to detect faces, or predetermined forms, etc. However, it is also possible to look for zones 19 of uniform color or low contrast, and to retain zones complementary to these as interest zones.

The step of automatically looking for interest zones is shown on the FIGURE as reference 20. It enables, in the illustrated example, two interest zones to be determined corresponding to a face and a tree. The zones are shown on the FIGURE by a dot-and-dash line. For each of the interest zones detected, additional shots 22a and 22b, respectively, are made automatically. The second images captured have references 24a and 24b.

Although the frame of second images does not necessarily correspond with the whole field of the image supplied by the sensor, it surrounds the interest zone which thus profits from larger optical enlargement because of the increase in focal length and the reduction of the field of view of the lens.

Indeed, the camera 13 is equipped with a lens 26 with variable focal length and possibly variable optical axis. This lens is controlled by the central processing unit 14, in response to the detection of interest zones, so as to tighten the framing, and thus the shooting field, around each of the interest zones detected. The second images 24a, 24b are captured. Actuators modifying the lens axis or the orientation of an optical wedge can also be controlled by the central processing unit 14. The purpose of this is to point the optical axis to the interest zones, so as to center the framing on these zones during the capture of the second images. As far as the maximum focal length available allows, the interest zones are captured “full frame” so as to occupy the greatest possible surface area on the image sensor. This measure enables the maximum useful digital data corresponding to the interest zones to be obtained.

The data of the first image 12 and the second images 24a and 24b are collected by the central processing unit 14 to establish in a last step 30 a composite image 32 in which the digital data of the interest zones 16a, 16b of the first image are replaced by the digital data of the second images 24a and 24b. The replacement is performed following the adjustment of the dimensions of the images 24a, 24b. The composite image 32 finally obtained thus has zones of lower resolution and zones of higher resolution. The latter correspond to the interest zones. When the composite image finally obtained is enlarged, it remains highly detailed in the interest zones. Thus, and despite a more limited resolution around the interest zones, enlargement of the image 32 does not prejudice its overall apparent quality. Thus the image can be displayed on a large screen, or be the subject of a photographic hardcopy.

An appropriate analysis of the geometrical and/or colorimetric differences between the images 16a and 24a as well as 16b and 24b enables, if necessary, the images 24a and 24b to be modified to produce a composite image 32 of optimal quality.

Indeed, an additional step 28, prior to creating the final composite image, can comprise various formatting operations of the data of the second images captured. One of these operations consists, for example, in recalculating a prior position of the iconic content of the second images to correct any movement due to the displacement of the iconic content or any movement by the camera user. The operation comprises, for example, the establishment of displacement vectors obtained from the two images, adjusted to the same baseline and resolution, representing the same interest area and corresponding respectively to one of the second images and the related area in the first image. There then follows a point-by-point correction phase of the second images, or possibly the first image. The degree of correction depends directly on the amplitude and direction of the previously estimated displacement vectors. The operation can also comprise the shift of the iconic elements of the second images en bloc in order to best superimpose them on the corresponding iconic elements of the interest zones of the first image. This can take place by minimizing a correlation function between the interest zones of the first and second images.

The additional step 28 can also be used to possibly remove second images which turn out to be accidentally out-of-focus or whose iconic contents are accidentally too different from that of the first image to allow insertion. In this case the data of the corresponding interest zone of the first image are conserved in the final image.

In the FIGURE, the camera 13 is represented as a photographic camera. However, it can be replaced by any digital camera equipment and especially by a phonecam that includes the functions mentioned.

### Documents Cited

(1) WO 03/069380
(2) EP 1 019 758
(3) U.S. Pat. No. 6,686,956
(4) “Super-Resolution Image Reconstruction” IEEE Signal Processing Magazine 1053/5888/03 May 2003 pages 21-36
(5) US 2004/0041919
(6) Ming-Hsuan Yang, David Kriegman, and Narendra Ahuja, “Detecting Faces in Images: A Survey”, IEEE Transactions on Pattern Analysis and Machine Intelligence (PAMI), vol. 24, no. 1, pp. 34-58, 2002.
(7) Jiebo Luo, Amit Singhal, Stephen R Etz, Robert T Gray, “A computational approach to determination of main subject regions in photographs”, Image and Vision Computing, 2001

1) A shooting method in response to a shot release, the method comprising:
capturing a first image according to a first shooting field, using a camera equipped with a variable focus lens set to a first focal length,
automatically searching the first image for at least one interest zone
the automatically modifying a focal length so as to tighten the shooting field around the interest zone,
automatically capturing at least one second image according to the tightened shooting field, and
automatically creating a composite image by combining the first image and the second image.

2) A method according to claim 1, further comprising automatically focusing, respectively on each interest zone at the time of capturing each second image.

3) A method according to claim 1, further comprising modifying the variable focal length of the lens to automatically direct an optical axis of the lens, respectively to each interest zone, at the time of capturing each second image.

4) A method according to claim 1, further comprising estimating movement of the iconic content of each interest zone and correcting at least one among the first and second images to compensate for the movement of the iconic content between the capture of the first image and respectively each of the second images.

5) A camera (13) comprising a lens with a variable focal length and analysis means of a first captured image for the detection of interest zones within the first image, the lens being controlled by the analysis means to perform a framing tightened around at least one interest zone of the first image, for the automatic capture of at least one second image corresponding to the interest zone and means for creating a composite image using the first captured image and the second captured image with a tightened field.

6) A camera according to claim 5, wherein the image analysis means and the means to create a composite image include a central processing unit.

7) A camera according to claim 5, wherein the variable focal length lens is an electrically addressable liquid lens system.
